(19) United States
(12) Patent Application Publication
(10) Pub. No.: US 2011/0260969 A1
(43) Pub. Date: Oct. 27, 2011

(54) REMOVABLY ATTACHABLE CONTROLLER FOR PORTABLE ELECTRONIC DEVICES

(76) Inventor: Brandon Workman, Rockford, IL (US)

(21) Appl. No.: 13/091,117

(22) Filed: Apr. 20, 2011

Related U.S. Application Data
(60) Provisional application No. 61/326,627, filed on Apr. 21, 2010.

(51) Int. Cl. G06F 3/033

(52) U.S. Cl. 345/161

(57) ABSTRACT

A method and apparatus for removably attaching a controller onto a portable electronic device to control the operation of that device and, more specifically, to a joystick and button controller which is removably attached to the device that communicates through software with the device and is connected to the device by wire or wirelessly. A rechargeable Bluetooth chip and associated circuit is located in the controller and a joystick and action buttons are functionally coupled to the Bluetooth chip and associated circuit and, through the controller to the portable electronic device. The joystick and action buttons are removably attached to the portable electronic device.

REFERENCE TO RELATED APPLICATIONS

This patent application claims the benefit of U.S. Provisional Application No. 61/326627 filed on Apr. 21, 2010, the disclosure of which is incorporated herein by reference in its entirety.

### BACKGROUND OF THE INVENTION

1. Field of the Invention

The present invention relates generally to a method and apparatus of removably attaching a controller onto a portable electronic device with a display, communication and operation of that device, and more specifically to a joystick and button controller which is removably attached to the device and communicates through software with the device and is connected to the device by wire or wireless. In the case where the electronic device is a tablet computer, a user will attach the joystick and action buttons onto the frame or screen. In the case where the electronic device is a laptop computer, the user will attach the joystick and action buttons onto the frame, screen of keyboard area. in the case where the electronic device is a mobile device, the user will attach the joystick and action buttons onto the frame or screen. When the controller is not being used, the joystick and action buttons can be easily removed from the device and placed into one or more storage areas. The joystick is a multi-direction stick and the action buttons are four buttons or directional pads. Each is removably attached to the device with a non-residue, removable micro suction tape, or removable suction cup, or a hook and loop type of removable fastening device such as a Velcro fastener or by magnets which are permanently affixed to the bottom of the joystick and the action buttons.

2. Description of Related Art

Controllers for mobile devices are known in the prior art, however, they are separate from the mobile devices and are not attachable. More specifically, by way of example, U.S. PreGrant Publication No. 2009/0227284 to Jones discloses a cellular hand set with a game controllers attached as part of the overall device.

U.S. PreGrant Publication No. 2008/0172610 to Blair discloses a controller console that does not appear to be attached to the computer screen.

U.S. PreGrant Publication No. 2006/0030380 to Pentinpuro discloses a phone where the game console flips out to the sides.

### SUMMARY OF THE INVENTION

In an exemplary embodiment of the present invention, there is disclosed apparatus for a portable electronic device comprising:

a display on a portable electronic device;

a controller adapted to be removably coupled to the portable electronic device;

a rechargeable Bluetooth chip and associated circuit located in the controller; and

a joystick functionally coupled to the Bluetooth chip and associated circuit and, through the controller, to the portable electronic device;

wherein the joystick is removably attached to the portable electronic device.

In another embodiment there is disclosed a method for controlling a display on a portable electronic device comprises:

providing a portable electronic device having a display;

removably coupling a controller adapted to the portable electronic device;

locating a rechargeable Bluetooth chip and associated circuit in the controller; and

functionally coupling a joystick to the Bluetooth chip and associated circuit and, through the controller, to the portable electronic device;

wherein the joystick is removably attached to the portable electronic device.

The present invention relates to removably attaching a controller onto a portable electronic device with a display, to communicate with and control the operation of that device, and more specifically to a joystick and button controller which is removably attached to the device and communicates through software with the device and is connected to the device by wire or wireless. In the case where the electronic device is a tablet computer, a user will attach the joystick and action buttons onto the frame or screen. In the case where the electronic device is a laptop computer, the user will attach the joystick and action buttons onto the frame, screen of keyboard area. in the case where the electronic device is a mobile device, the user will attach the joystick and action buttons onto the frame or screen. When the controller is not being used, the joystick and action buttons can be easily removed from the device and placed into one or more storage areas. The joystick is a multi-direction stick and the action buttons are four buttons or directional pads. Each is removably attached to the device with a non-residue, removable micro suction tape, or removable suction cup, or a hook and loop type of removable fastening device such as a Velcro fastener or by magnets which are permanently affixed to the bottom of the joystick and the action buttons.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a perspective view of the game controller, joystick and action buttons for portable electronic devices with a display where the joystick and the action buttons are removably attached to a tablet computer to provide a display of increased size in accordance with the principles of the invention; and

FIG. 2 is a perspective view of the joystick and action buttons located in the game controller.

### DESCRIPTION OF THE PREFERRED EMBODIMENT

There is disclosed a controller, a joystick, and action buttons for portable electronic devices, including but not limited to the Motorola Droid, Apple iPhone, mp3 players including but not limited to the Apple iPod Touch and Microsoft Zune and, with a larger size which is applicable to the Apple iPad, computer tablets, netbooks and laptop computers.

Video games played on mobile phones and mobile computers can be awkward and difficult, and when the game play is awkward and difficult, it can deny the player/user of a satisfying experience. Video game players greatly depend on the responsiveness and comfort level the user feels with the control mechanism that interacts with that which is going on in the on-screen video game world. For example, currently a simple movement UP in a video game on a touch screen phone requires the user to swipe or press his or her finger on a specific location such as a virtual joystick on the screen to execute that action. This type of action be a player provides an unsatisfying gaming experience for many users.

A game controller with a joystick and buttons which are removably attached to the frame around the screen of a computer would solve this problem. Pushing one's thumb UP on a physical joystick that signals movement along the Y axis which executes a subsequent UP action on the screen in the game would better satisfy the hands-on experience many gamers seek. Working in concert with the joystick, pressing corresponding action buttons will execute jump or fire commands.

The issue with utilizing a physical game controller for a mobile touch screen device is size limitations. Screens are small and a controller the size of the device is not ideal nor is it practical to carry it around.

The solution is to removably attach a minimally invasive Bluetooth enabled, rechargeable joystick and corresponding Bluetooth enabled, rechargeable action buttons to the surface of the touch screen device with a removable suction cup or a hook and loop type of removable fastening device such as a Velcro fastener or by magnets. The joystick and action buttons are wired directly to the input source of the mobile device, for example, a USB for a netbook or via a 30 pin connector on an iPhone. The user has the freedom to removably attach the joystick and action buttons any place on the device. For a mobile touch screen device such as a netbook or laptop, attaching the joystick with a removable suction cup and action buttons with a removable suction cup to the lower left and right sides or corners of the screen would be unobtrusive to the on-screen viewing surface and effective in meeting the high standards of today's mobile gamer.

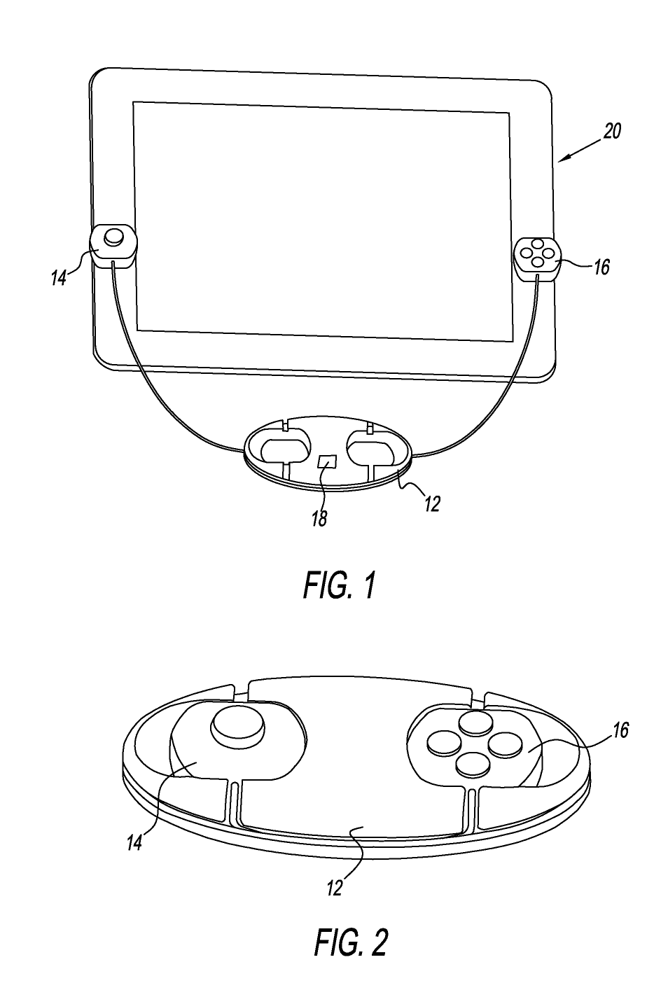

Referring to FIG. 1 there is disclosed a perspective view of the game controller, joystick and action buttons for portable electronic devices with a display where the joystick and the action buttons are removably attached to the screen of a portable electronic device with a display to provide an image of increased size in accordance with the principles of the invention. A controller 12 is coupled through conductive wires to a joystick 14 and action buttons 16. The Joystick and the action buttons are attached to a portable electronic device with a display with a non-residue, removable micro suction tape, or removable suction cup or a hook and loop type of removable fastening device such as a Velcro fastener or by magnets which are permanently affixed to the bottom of the joystick and the action buttons, The Joystick and action buttons may be located on the lower left and right sides or corners of the portable electronic device with a display 20. A rechargeable Bluetooth chip and circuitry 18 is coupled to the game controller 12. Referring to FIG. 2 there is shown a perspective view of the joystick 14 and action buttons 16 located in the game controller 12.

The joystick and action buttons of the controller are removably attached to the surface of a portable electronic device with a display with a non-residue, removable micro suction tape, or removable suction cup, or a hook and loop type of removable fastening device such as a Velcro fastener or by magnets which are permanently affixed to the bottom of the joystick and the action buttons and lock firmly onto the portable electronic device with a display. This allows a user to be up close to the on-screen action, thus allowing for a more visceral experience, and a more user-friendly yet effective means of going about playing a mobile game.

They are as effective as virtual controls yet provide the user the hands on experience. They are easily and quickly removable to restore other functions of the mobile device. Advantages will become apparent from a study of the following description and accompanying drawing.

FIG. 1 is a perspective view showing the action buttons 16 on the user's right side and the joystick 14 on the user's left side. The oval shaped member 12 represents a storage unit for the controller. The action buttons 16 are mounted on suction cup and the joystick 14 is mounted on a suction cup. A rechargeable Bluetooth chip and circuitry housing 18 is located within the game controller 12.

In operation, one uses the controller wired to or wirelessly with the portable electronic device with a display. The user must turn on or plug in the respective joystick and action buttons to activate functionality. For Bluetooth to function properly, as with a Bluetooth headset, it must be paired with the mobile device in order for movement of the joystick and action buttons of the controller to sync navigation of the portable electronic device with a display.

Paring may be obtained without altering the software or hardware in the controller by coupling the communication port of the portable electronic device with a display to a user interface apparatus which includes a microprocessor that converts instructions from the user interface apparatus to an instruction which is performed by the controller. Thus, while the interface apparatus may be different from both the controller and the interface apparatus in the controller, instructions from the interface apparatus are formatted the same as instruction from the controller.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. Apparatus for a portable electronic device comprising:
a display on a portable electronic device;
a controller adapted to be removably coupled to the portable electronic device;
a rechargeable Bluetooth chip and associated circuit located in the controller; and
a joystick functionally coupled to the Bluetooth chip and associated circuit and, through the controller, to the portable electronic device;
wherein the joystick is removably attached to the portable electronic device.

2. The apparatus of claim 1 further comprising:
action buttons functionally coupled to the Bluetooth chip and
associated circuit and, through the controller, to the portable electronic device; and
the action buttons are removably attached to the portable electronic device.

3. The apparatus of claim 2 wherein the joystick and the action buttons are removably attached to at least one side of the portable electronic device.

4. The apparatus of claim 3 wherein the joystick is removably attached to one side of the portable electronic device and the action buttons are removably attached to the other side of the portable electronic device.

5. The apparatus of claim 4 wherein the joystick and the action buttons are removably attached to the lower hafts of the portable electronic device.

6. The apparatus of claim 5 wherein the joystick and the action buttons are removably attached to the lower corners of the portable electronic device.

7. The apparatus of claim 4 wherein the joystick and the action buttons are removably attached to the portable electronic device with suction cups.

8. The apparatus of claim 4 wherein the joystick and the action buttons are removably attached to the portable electronic device with hook and loop connectors or with magnets.

9. The apparatus of claim 7 wherein the portable electronic device is a tablet.

10. The apparatus of claim 7 wherein the portable electronic device is a netbook.

11. The apparatus of claim 7 wherein the portable electronic device is a laptop.

12. A method for controlling a display on a portable electronic device comprises:
providing a portable electronic device having a display;
removably coupling a controller adapted to the portable electronic device;
locating a rechargeable Bluetooth chip and associated circuit in the controller; and
functionally coupling a joystick to the Bluetooth chip and associated circuit and, through the controller, to the portable electronic device;
wherein the joystick is removably attached to the portable electronic device.

13. The method of claim 12 further comprises:
functionally coupling action buttons to the Bluetooth chip and associated circuit and, through the controller to the portable electronic device; and
removably attaching the action buttons to the portable electronic device.

14. The method of claim 13 wherein the joystick and the action buttons are removably attached to at least one side of the portable electronic device.

15. The method of claim 14 wherein the joystick is removably attached to one side of the portable electronic device and the action buttons are removably attached to the other side of the portable electronic device.

16. The method of claim 15 wherein the joystick and the action buttons are removably attached to the lower hafts of the portable electronic device.

17. The method of claim 16 wherein the joystick and the action buttons are removably attached to the lower corners of the portable electronic device.

18. The method of claim 15 wherein the joystick and the action buttons are removably attached to the portable electronic device with suction cups.

19. The method of claim 15 wherein the joystick and the action buttons are removably attached to the portable electronic device with hook and loop connectors, or suction cups or magnets.

20. The method of claim 18 wherein the portable electronic device is a tablet, a notebook or a laptop
